(19) United States
(12) Patent Application Publication
(10) Pub. No.: US 2009/0212019 A1
(43) Pub. Date: Aug. 27, 2009

(54) SINGLE-SIDED HIGH THROUGHPUT WET ETCHING AND WET PROCESSING APPARATUS AND METHOD

(76) Inventor: Ricardo I. FUENTES, Hopewell Junction, NY (US)

Correspondence Address: KENYON & KENYON LLP, ONE BROADWAY, NEW YORK, NY, 10004, US

(21) Appl. No.: 12/390,993

(22) Filed: Feb. 23, 2009

Related U.S. Application Data
(60) Provisional application No. 61/066,802, filed on Feb. 22, 2008.

(51) Int. Cl. C23F 1/00; C03C 15/00

(52) U.S. Cl. 216/92; 156/345.21

(57) ABSTRACT

A processing system includes a plurality of chucks, each of the chucks configured to support a substrate such that a bottom surface of the substrate is exposed, a track configured to guide the plurality of chucks along a continuous path, and a processing arrangement configured to process the bottom surface of each substrate when the track guides the respective chuck over the processing arrangement, the processing arrangement including a fluid meniscus arranged to contact the bottom surface of each substrate when the track guides the respective chuck over the processing arrangement.

### CROSS-REFERENCE TO RELATED APPLICATIONS

This application claims the benefit of U.S. Provisional Patent Application No. 61/066,802, filed on Feb. 22, 2008, which is expressly incorporated herein in its entirety by reference thereto.

### FIELD OF THE INVENTION

This present disclosure relates generally to an apparatus that exposes multiple substrates' bottom-facing surfaces to a fluid medium while holding them from above by a variety of structures or mechanisms.

### BACKGROUND

There are a great variety of machines, devices that wet process (e.g., etch) substrates of a variety of materials, but lack the capability of single-sided wet processing, particularly with strong chemical solutions, of a large number of substrates in a short period of time. A “high throughput machine” should be capable of processing a high number, e.g., hundreds to thousands, of substrates per hour.

Most high throughout machines feed and move the substrates during processing via rollers into a wet bath. The substrates processed in such way are usually submerged fully into the solution thus limiting the process capabilities of such systems to processes that wet both sides of the substrate.

In cases where the substrates are allowed to move over the rollers or a functionally equivalent device, the top surface of the substrates are exposed to vapors, thus also limiting the process capabilities of such systems. Vapor damage prevention to the top surface would require some form of protection, such as resist, or other. The addition of these layers adds steps and expense to the processing of substrates by such apparatuses. In this regard, it may be desirable to reduce the cost per substrate by eliminating the need for these additional layers and steps.

### SUMMARY

According to an example embodiment of the present invention, a processing system includes: a plurality of chucks, each of the chucks configured to support a substrate such that a bottom surface of the substrate is exposed; a track configured to guide the plurality of chucks along a continuous path; a processing arrangement that processes the bottom surface of each substrate when the track guides the respective chuck over the processing arrangement. The processing arrangement may include a fluid meniscus arranged to contact the bottom surface of each substrate when the track guides the respective chuck over the processing arrangement. The path may lie, e.g., within a horizontal or vertical plane.

According to another example embodiment of the present invention, a processing system includes: a chuck configured to support a substrate such that a bottom surface of the substrate is exposed; a track configured to guide the chuck along a continuous path; and a processing arrangement configured to process the bottom surface of the substrate when the track guides the chuck over the processing arrangement, the processing arrangement including a fluid meniscus arranged to contact the bottom surface of the substrate when the track guides the chuck over the processing arrangement. The path may lie, e.g., within a horizontal or vertial plane. The system may include a plurality of chucks.

According to another example embodiment of the present invention, a processing system includes: a plurality of chucks, each of the chucks configured to support a substrate such that a bottom surface of the substrate is exposed; a conveyor that guides the plurality of chucks along a continuous path; and a processing arrangement to process the bottom surface of each substrate when the track guides the respective chuck over the processing arrangement. The processing arrangement may include a fluid meniscus arranged to contact the bottom surface of each substrate when the conveyor guides the chucks over the processing arrangement. At least two of the chucks may be laterally spaced and arranged at the same location along the path. The conveyor may include a plurality of links, e.g., articulating links. At least two of the chucks may be disposed laterally on a common link. The chucks may be provided in conjunction with multifunction heads and/or planar heads. The chucks may be built into the conveyor.

According to an additional example embodiment of the present invention, a method of processing substrates includes: mounting a plurality of substrates to a plurality of chucks; moving the chucks along a track that forms a continuous path; passing the substrates over a processing arrangement such that the processing arrangement causes exposed bottom surfaces of the substrates to be processed. The processing arrangement may include a fluid meniscus arranged to contact the bottom surfaces of the substrates during the passing step. The passing step may include etching the bottom surfaces of the substrates, cleaning the bottom surfaces of the substrates, rinsing the bottom surfaces of the substrates, and/or drying the bottom surfaces of the substrates, or any other appropriate form of substrate processing.

According to another example embodiment of the present invention, a method of processing substrates includes: mounting a substrate to a chuck; moving the chuck along a track that forms a continuous path; and passing the substrate over a processing arrangement such that the processing arrangement causes exposed bottom surface of the substrate to contact a fluid meniscus of the processing arrangement. The passing step may include etching the bottom surface of the substrate, cleaning the bottom surface of the substrate, rinsing the bottom surface of the substrate, and/or drying the bottom surface of the substrate, or any other appropriate form of substrate processing.

According to example embodiments of the present invention, a processing apparatus will only expose the bottom-facing surface of a substrate without wetting or contaminating, by neither vapor nor liquid, the top surface. Further, the apparatus may process large numbers of substrates per hour and many substrates at a time in this manner.

A chuck or an array of chucks may be used to hold a substrate from above to allow contact or exposure of the bottom of the wafer to a process, medium, liquid, gas, spray, among other types of exposures, while no medium comes in contact with the non-process side of the substrate.

Even though the capability of processing one side of a substrate is a unique feature of the present invention, a substrate can be processed on both sides by having the machine “flip” the substrate and processing the second side. The flipping can happen within the tool, track, load/unload positions, and other suitable places.

Further, the machine subject of this invention can be placed in conjunction with others of similar characteristics, side-by-side (parallel) , one before the other (serial), or in combinations thereof; in order to effect more complex processes, use of multiple chemistries, to process multiple sides, or for a variety of other suitable purposes.

The process steps or stations may include positions and devices for treating the surface of the substrates with virtually any chemical, solvent, water, polymer, among others, as well as other liquids and gases; either at room temperature or at other convenient temperature. Such treatments can be, among others, for the purposes of etching, stress relieving, dissolving, rinsing, cleaning, drying, surface coating, or producing a variety of effects on the surfaces of said substrates, or depositing or growing a coating on such.

One purpose of the example device is to hold a substrate, such as a solar cell, glass, or device wafer—of any kind—such as to expose its underside to a process—of any suitable kind—while avoiding contact of the fluid medium with the non-process side. Even though this apparatus is useful on its own or while incorporated in a variety of systems, tools, or other devices; it may be particularly useful in conjunction with an apparatus described in U.S. Pat. No. 7,122,126 entitled WET PROCESSING USING A FLUID MENISCUS, APPARATUS AND METHOD, which is expressly incorporated herein in its entirety by reference thereto.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a processing system according to an example embodiment of the present invention.

FIG. 2 shows a processing system according to a second example embodiment of the present invention.

FIG. 3 shows a processing system according to a third example embodiment of the present invention.

FIG. 4 shows a processing system according to a fourth example embodiment of the present invention.

FIG. 5 shows a processing arrangement according to an example embodiment of the present invention.

### DETAILED DESCRIPTION

An example embodiment of the present invention may take the form of a multiplicity of chucks to hold substrates during wet processing. The chucks may perform a variety of functions aside from holding the substrate, such as spinning and/or drying the substrate. Also, the chucks may expose or present the substrates to, e.g., rinsing, drying, scrubbing, coating devices or coating stations, among others. The chucks can be of a variety of types and hold the substrate by a variety of mechanisms, such as vacuum, electrostatic, and mechanical, among others.

In this particular application, the subject of this invention is capable of processing a multiplicity of substrates at a time by arranging the chucks on a vertical or horizontal track, multiple tracks, on a “conveyor,” “merry go around,” or combinations of the above. It should be appreciated that there are many other arrangements of said multiplicity of chucks according to other example embodiments of the present invention.

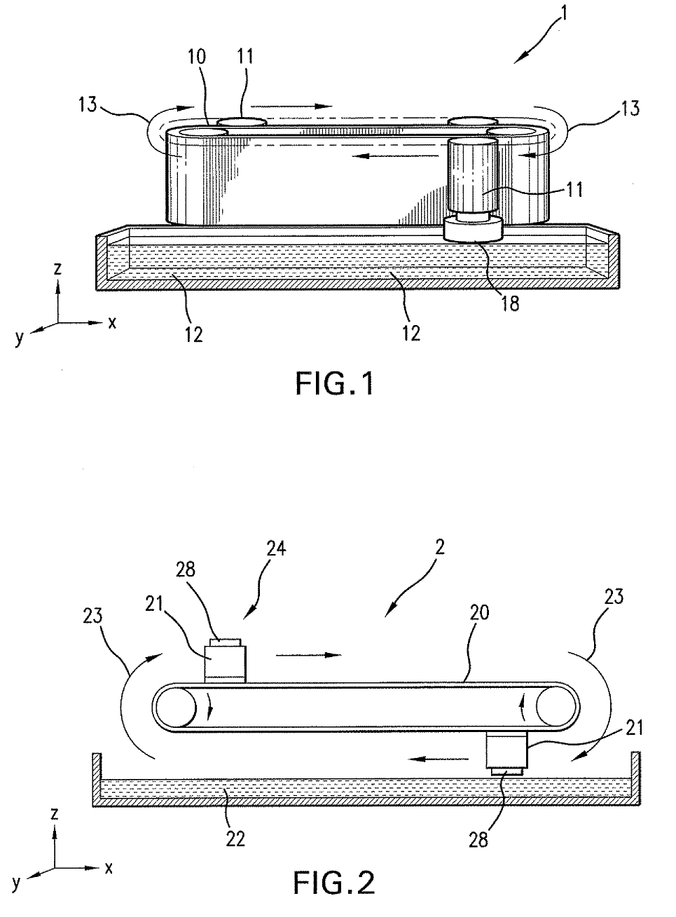

Referring to FIG. 1, an example system 1 includes a track 10 having multiple chucks 11. Although the track 10 has multiple chucks, it should be appreciated that any number of chucks, including a single chuck, may be provided. The track 10 moves the chucks 11 over “liquid menisci” 12 of processing fluid. The chucks 11 may pick up the substrates 18, which may transferred to the chucks at different possible locations in the system, by a suitable mechanism or by human intervention. The multiple chucks or “heads” may act in concert or independently. The multiplicity of heads and liquid menisci may be dynamically configured for the system herein described to act as multiple “virtual” wet processing tools. The system may also act as a single tool operating in series, parallel or a combination of series and parallel, depending on the process requirements.

The tracks may be arranged in such a way as to move the multiple heads along a path 13 that is always parallel to the process plane or the horizontal plane of the ground. This embodiment is particularly useful in allowing for different processes, steps, or fluids to be used in series or parallel, or a combination thereof, in the same apparatus.

Referring to FIG. 2, a second example system 2 includes a track 20 arranged to move the heads 21 along a path 23, only a portion of which carries the heads 21 over the fluid menisci 22, and the other portion carries the heads back, with their chucks (i.e. surface where the substrate 28 is held) in an upward-facing orientation 24. This example embodiment may be particularly useful in allowing multiple tracks set, or integrated into a single tool or system, side-by-side for greater processing capacity.

Although the path 13 of the system of FIG. 1 lies entirely in a horizontal plane and the path 23 lies entirely in a vertical plane, it should be appreciated that the path 13, 23 may lie in any appropriate plane, combination of planes, and/or a more complex two- or three-dimensional path.

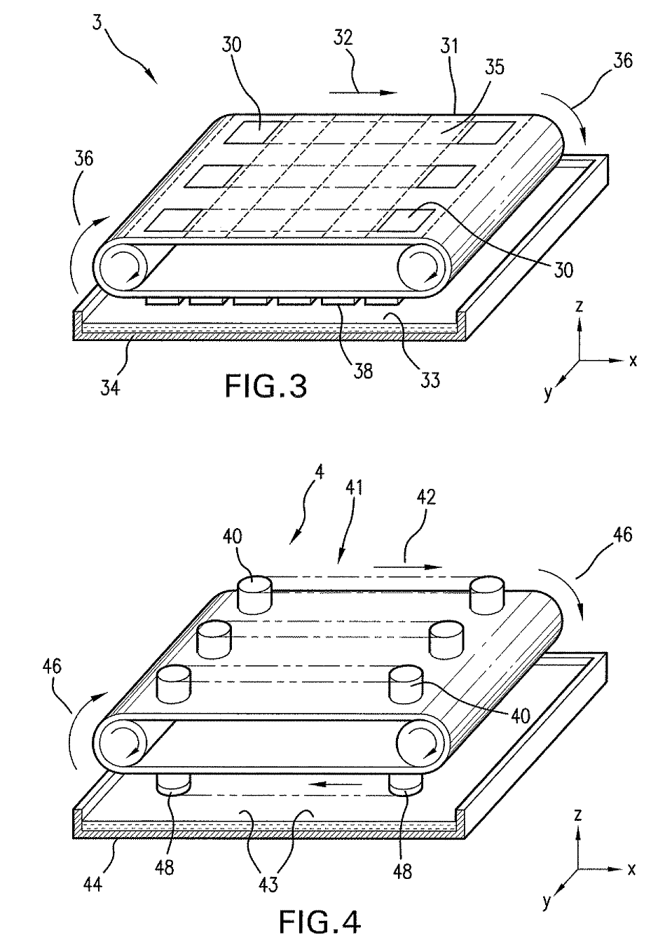

Referring to the example systems 3 and 4 of FIGS. 3 and 4, a multiplicity of heads 30, 40 may be arranged in a conveyor surface 31, 41 in such a manner that one or more heads can pick up, process, and deliver substrates at a time. The conveyor moves along a path 32, 42 that brings the heads 30, 40 and substrates 38, 48 over the fluid menisci 33, 43 and throughout any other desired positions, such as load, unload, rinse, and dry, among others. The fluid meniscus or menisci can be located inside a “wet module” 34, 44 that handles all fluid feed, mixing, and drain functions.

Referring to FIG. 3, the surface of the conveyor consists of multiple, articulated, links 35. Each link may have multiple heads, side-by-side and many links together will make up the conveyor. The conveyor can be implemented in a variety of manners, one such being one that carries it in a path 36, 46 around and over the liquid menisci 33, 43 and wet module 34, 44.

It should be appreciated that many different embodiments of the track and conveyor components that are possible, e.g., those not using a “linked” structure or of a different layout, structure, material, geometry, width, length, height, and size in general, and are all contemplated herein as example embodiments of the present invention.

One such embodiment uses heads and chucks as described in U.S. patent application Ser. No. 11/603,571 entitled DEVICE AND METHOD FOR HOLDING A SUBSTRATE, which is expressly incorporated herein in its entirety by reference thereto, and are generally non-planar heads with a variety of functions built into the heads themselves. Referring to FIG. 4, multifunction heads and chucks are mounted in a S conveyor arrangement 40. Referring to FIG. 3, planar heads are mounted in similar track arrangement 30. The heads and chucks described herein are only two different holding mechanisms to do such holding, but a variety of additional embodiments is conceivable without departing from the invention. The choice of head and chuck will depend on details of the desired implementation. It should be appreciated that different methods of holding the substrates may be used according to other embodiments of the present invention.

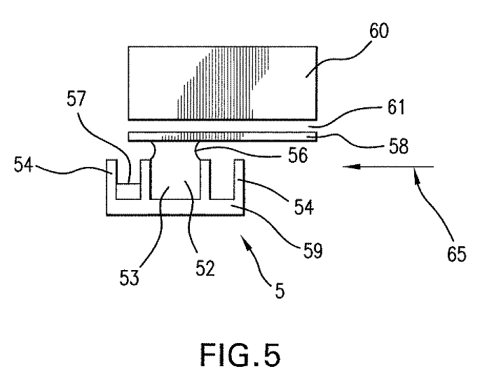

Referring to FIG. 5, a processing arrangement 5 is illustrated. The processing arrangement 5 may be provided with, e.g., any of the embodiment described herein. A substrate head 60 holds and guides a substrate 58 (e.g., the substrate 18, 28, 38, and 48 described above) over the processing arrangement 5 along a path 65. In this example embodiment, the processing fluid 53, used for processing is being continuously replenished into a fluid channel 52. This may be accomplished using either an open or closed loop system (i.e., the fluid 53, used discarded after one pass, or recycled, with or without any form of treatment, to go back into the fluid channel). The chemistry of the fluid 53, may be adjusted during such passes or not. Similarly, the temperature, or other properties, of the fluid 53, may be adjusted during such passes or not. Such choice may be dependent on a variety of aspects, such as environmental, economical, process issues, throughput, and uniformity, among others. During normal operation as part of the re-circulation process or as overflow during the passage of the substrate 58, over it, the fluid 53, in the fluid channel 52, may overflow into the overflow channels 54, so that the overflowed fluid 57, can be further processed, such as, discarded, recycled, replenished by combining with a fresh batch o fluid 53, and injected back into the fluid channel 52. The fluid 53, collected therein is either accumulated, disposed of, or re-circulated. In an example embodiment vacuum is applied to the overflow channels 54, to assist in the transport of liquid 53, along its intended path; but any other arrangements, including overflow aided just by the force of gravity, vacuum-gravity combinations, chemical reaction, or electrostatic forces, or combinations thereof, may be provided. It should also be appreciated that several configurations are conceivable regarding the liquid handling aspects of the system, such as different liquid removal, accumulation, pumping, confinement, and management implementations; among others. Similarly, other geometries, arrangements, or embodiments regarding the configuration, size, shape or other characteristics of the liquid or overflow channels; including the absence, partial or total of either one of them, may also be provided according to example embodiments of the present invention. Similarly, any configuration involving a multiplicity, or any number, of the same channels or modules may also be provided. In the example embodiment illustrated at FIG. 5, a gas current may be employed employed through the gap 61, between the substrate 58, and the head 60, to help prevent fluid 53, creeping or moving up onto the top surface of the substrate 58.

It should be appreciated that the substrate 58 may be exposed to more than one liquid meniscus 56 (e.g., a meniscus 12, 22, 33, or 43 described above), per pass. The number of liquid modules 59 used may depend on a variety of factors, such as desired process rates, throughput, substrate geometries, among others. It should be appreciated that many variants and combinations are conceivable and may be provided according to embodiments of the present invention.

The processing arrangement 1 illustrated in FIG. 5 is only one of many possible configurations. It should be appreciated that any appropriate processing arrangement may be provided. For example, any of the configurations described in U.S. Pat. No. 7,122,126, may be provided in embodiments of the present invention.

Even though a large number of possible applications are possible, in its preferred embodiment the current invention provides a substantial improvement over prior systems in providing for an effective method to hold and wet process a substrate or multiplicity of substrates in a single-sided manner (i.e., not exposing the non-process side to the wet medium or to any significant extent to its vapors). This may be particularly important in wet processing applications where the process side is exposed to a liquid which is often corrosive. In these circumstances, it is imperative that the non-process side is not exposed to the liquid.

State of the art applications call for such arrangements. In particular, the wet processing apparatus and method described in U.S. Pat. No. 7,122,126 B1 entitled WET PROCESSING USING A FLUID MENISCUS, APPARATUS AND METHOD, which is expressly incorporated herein in its entirety by reference thereto, will benefit greatly from this invention. Other processes that require face-down arrangements will benefit in a similar manner.

The object of the present invention may also be used advantageously to process substrates that because of their market economics or application requirements, there is a need to process a high number of substrates per hour. Different embodiments of this invention are capable of wet processing from hundreds to thousands of substrates per hour. The highly parallel processing arrangement that the subject of this invention allows for, along with its single-sided capabilities constitute a great economical and technological advantage over prior state of the art.

A technology area that benefits specially from the subject of this invention is that deals with the manufacture of solar cells. The manufacturing of said devices requires the processing of thousands of wafer per hour per machine. This technology area also requires single-sided processes. One such process step is the “texturing or roughening of one side of the cell substrate. The particular manner by which the substrate is exposed to the chemicals when using the subject of this invention, enables for unique texturing capabilities and control over the resulting surface characteristics unlikely to be obtained by prior art methods. There are other process steps that would also benefit from the availability of the single-sided high-throughput apparatus subject of this invention. By making use of the apparatus subject of this invention, said manufacturing will be able to reduce the cost and improve the quality and efficiency of said cells; both critical factors in the widespread acceptance of solar energy as an economically viable alternative to fossil fuels.

Materials processed or by the apparatus subject of this invention can be all solids and semisolids, and any other material, composite, aggregate or material form that can be held by any arrangement of the present invention and therefore are also subject of this invention.

All above purposes and forms are also contemplated as subject of the present invention. Although many embodiments, variations and combinations are conceivable, and also subjects of this invention; some such relevant embodiments and variations are as follow: (a) embodiments of the present invention, its variants, and its alternative embodiments, independently of its applications or tasks it to which it may be applied; (b) embodiments of the present invention made of any suitable material or combination of materials; (c) embodiments of the present invention made by any suitable manufacturing process or sequence of processes; (d) embodiments of the present invention with its holding devices, such as chucks and heads, of any shape, size, and type, in addition to those sizes depicted and described herein; (e) embodiments of the present invention making contact with the substrate or substrates in different points and/or in different arrangements or combinations as described herein; (f) embodiments of the present invention with a different shape, number of components, number of chucks and heads, and different geometry for itself and/or any of its components; (g) embodiments of the present invention made in a different shape, manner, materials, geometry or form, but with substantially the same purpose; (h) embodiments of the present invention made in a different shape, manner, materials, geometry or form, but with substantially the same operation principle; (i) embodiments of the present invention having the components or holding devices moved in different patterns or manners as those described herein, including the case of no motion at all; (j) embodiments of the present invention where each of the heads or chucks performs some, all, or none of the functions of spinning rinsing, drying, scanning, holding, when the whole chuck rotates, translates, moves up and/or down, or performs motions that are a combination including some or all of these motions; (k) embodiments of the present invention where the tracks or conveyors are made up in different ways to these described herein; (l) embodiments of the present invention where the tracks or conveyors move in different paths, manners, or directions as to these described herein, including no motion at all; (m) embodiments of the present invention where the tracks or conveyors are made from segments or links; (n) embodiments of the present invention where the tracks or conveyors are not made from segments or links; (o) embodiments of the present invention incorporated into a larger subsystem or apparatus to perform other processes where the subject of the embodiment of the invention holds or processes a substrate; (p) embodiments of the present invention used as a standalone device; (q) embodiments of the present invention where the holding device is part of the track or conveyer or embedded in the track or conveyor; and (r) embodiments of the present invention used for other applications not explicitly described herein.

It should be understood that there exist implementations of other variations and modifications of the invention and its various aspects, as may be readily apparent to those of ordinary skill in the art, and that the invention is not limited by specific embodiments described herein. Features and embodiments described above may be combined in various ways. It is therefore contemplated to cover any and all modifications, variations, combinations or equivalents that fall within the scope of the basic underlying principals disclosed and claimed herein.

What is claimed is:

1. A processing system, comprising:
a chuck configured to support a substrate such that a bottom surface of the substrate is exposed;
a track configured to guide the chuck along a continuous path; and
a processing arrangement configured to process the bottom surface of the substrate when the track guides the chuck over the processing arrangement, the processing arrangement including a fluid meniscus arranged to contact the bottom surface of the substrate when the track guides the chuck over the processing arrangement.

2. The processing system according to claim 1, wherein the path lies within a horizontal plane.

3. The processing system according to claim 1, wherein the path lies within a vertical plane.

4. The processing system according to claim 1, wherein the system comprises a plurality of chucks.

5. A processing system, comprising:
a plurality of chucks, each of the chucks configured to support a substrate such that a bottom surface of the substrate is exposed;
a conveyor configured to guide the plurality of chucks along a continuous path; and
a processing arrangement configured to process the bottom surface of each substrate when the track guides the respective chuck over the processing arrangement, the processing arrangement including a fluid meniscus arranged to contact the bottom surface of each substrate when the conveyor guides the chucks over the processing arrangement.

6. The processing system according to claim 5, wherein at least two of the chucks are laterally spaced and arranged at the same location along the path.

7. The processing system according to claim 5, wherein the conveyer includes links.

8. The processing system according to claim 7, wherein at least two of the chucks are disposed laterally on a common link.

9. The processing system according to claim 5, wherein the chucks are provided in conjunction with multifunction heads.

10. The processing system according to claim 5, wherein the chucks are provided in conjunction with planar heads.

11. The processing arrangement according to claim 5, wherein the chucks are built into the conveyor.

12. A method of processing substrates, comprising:
mounting a substrate to a chuck;
moving the chuck along a track that forms a continuous path; and
passing the substrate over a processing arrangement such that the processing arrangement causes exposed bottom surface of the substrate to contact a fluid meniscus of the processing arrangement.

13. The method according to claim 12, wherein the passing step includes cleaning the bottom surface of the substrate.

14. The method according to claim 12, wherein the passing step includes rinsing the bottom surface of the substrate.

15. The method according to claim 12, wherein the passing step includes drying the bottom surface of the substrate.
